(19) United States
(12) Patent Application Publication
(10) Pub. No.: US 2002/0099602 A1
(43) Pub. Date: Jul. 25, 2002

(54) Method and system to provide web site schedules

(76) Inventors: Paul Moskowitz, Yorktown Heights, NY (US); Stephen J. Boies, Mahopac, NY (US); Sam Dinkin, Austin, TX (US); Philip S. Yu, Chappaqua, NY (US)

Correspondence Address: MORGAN & FINNEGAN, L.L.P., 345 Park Avenue, New York, NY, 10154, US

(21) Appl. No.: 09/730,359

(22) Filed: Dec. 4, 2000

(51) Int. Cl. G06F 17/60; G06F 15/16

(52) U.S. Cl. 705/14; 709/217

(57) ABSTRACT

A system and method for providing web site update schedules to consumers. A consumer requests the web sites for which they would like to receive update schedules and the invention provides the update schedules to the consumer along with advertisements, promotions and recommendations for other web sites to visit. In one embodiment, these advertisements and recommendations are targeted to the consumers based on their interests. The update schedules for the various web sites can be obtained through several means. In one embodiment, the update schedules may be obtained by itself by crawling the web sites periodically or by receiving the update schedules directly from web sites that register with the system.

### FIELD OF THE INVENTION

The present invention relates generally to business methods and, more particularly, to a method and system for providing web site schedules to consumers.

### BACKGROUND OF THE INVENTION

Web sites on the Internet periodically update the content offered on their sites. These updates occur at different times for all of the different sites. Even newspaper sites which may have continuous updates throughout the day, also have major refresh times each day, at 6:00 a.m. for example. It is difficult for consumers to know whether or not a web site has been updated since their last visit to the site, or when that site will next update with new content. Even though some web sites post the time that the next update will occur, it is difficult and burdensome for an individual to keep track of these times themselves, even if they can find the information. It is hard for each individual to find out and keep track of the update schedule of each web site and it is frustrating and time-consuming for a consumer to visit a site that has not changed since the last time they have visited and to not know when the next update will occur. This problem may cause consumers to stop visiting sites altogether.

Additionally, web sites and advertisers need to get their names and products out to consumers who may be interested in what they have to offer. It is expensive and inefficient to advertise to broad cross-sections of people who may not be interested in the advertiser's product or service, and will therefore ignore, the enticements that are offered to them. Further, it is difficult for advertisers to target those consumers who may be most responsive to them. Accordingly, web sites and advertisers often have difficulty formulating strategies to effectively reach those particular consumers that will be most interested in their content or products.

### SUMMARY OF THE INVENTION

As set forth below, a need exists for a method and system for determining the update schedules of different web sites and making them available to consumers. The method and system of the invention satisfies that problem. According to one embodiment, the invention provides a single portal, or host web site, that consumers can visit that enables them to specify various web sites for which they want to know the update schedules. The system of the invention can track the interests of particular consumers based on the web sites that they have selected. This demographic information gives the host site leverage to make deals with other web sites or advertisers. When the host then displays the desired update schedules to the consumer, it can also display various advertisements, promotions and recommendations for other web sites to visit targeted directly to that particular consumer based on the subjects in which they are interested. In this manner, the consumers along with the web sites and advertisers all benefit. The consumer receives the update schedule, and other helpful information for the web sites that they have an interest, and the web sites and advertisers can effectively target those consumers that may be interested in their content and products.

The update schedules of the various web sites can be supplied to the host site by several means. In one embodiment, the host site can determine the update schedule of a particular web site by either “crawling” it periodically and analyzing its content or through the preferred method of having the web site register with the host system. When a web site registers with the system, the site provides its update schedule to the host system directly, and in exchange, the host site will display advertisements or recommendations for the web site to consumers along with the update schedule of that web site.

### BRIEF DESCRIPTION OF THE DRAWINGS

The accompanying drawings illustrate certain embodiments of the invention.

FIG. 1 illustrates a system according to one embodiment of the present invention;

FIG. 2 illustrates one embodiment of the central controller used in the system shown in FIG. 1;

FIG. 3 illustrates a sample of the contents of the consumer database stored in the central controller shown in FIG. 2;

FIG. 4 illustrates a sample of the contents of the web sites schedules database stored in the central controller shown in FIG. 2;

FIG. 5 illustrates a sample of the contents of the interests database stored in the central controller shown in FIG. 2;

FIG. 6 is a flowchart illustrating the consumer use process executed by the system shown in FIG. 1;

FIG. 7 is a flowchart illustrating a process of obtaining the update schedule of a web site that is not part of a consumer's personal site list executed by the system shown in FIG. 1;

FIG. 8 is a flowchart illustrating the web site registration process executed by the system shown in FIG. 1;

FIG. 9 is a flowchart illustrating a process of adding a new web site to the web site schedules database executed by the system shown in FIG. 1;

FIG. 10 is a flowchart illustrating the process of maintaining the database of web site schedules executed by the system shown in FIG. 10.

### DETAILED DESCRIPTION

System of the Invention

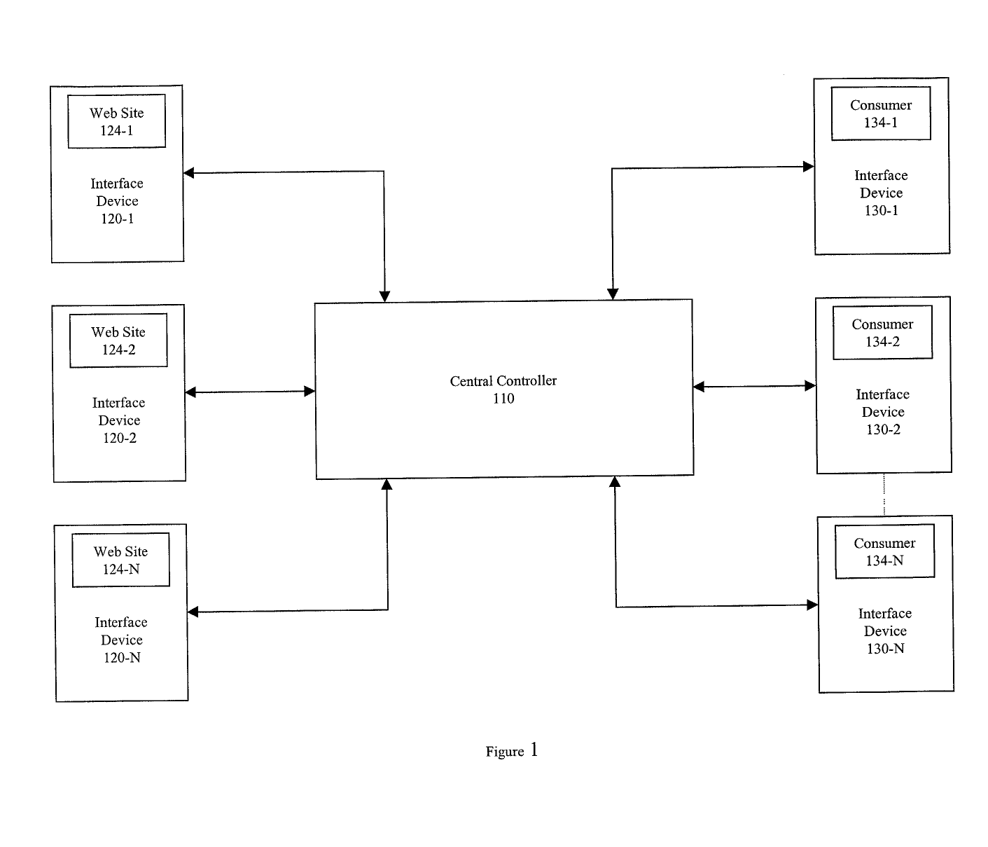

FIG. 1 shows one embodiment of a system incorporating the present invention. In this embodiment, the system includes a central controller 110, configured to receive information from one or more consumers 134 at remote consumer terminals or user interface devices 130, and obtains or receives information from at least one web site 124. The central controller 110 in this embodiment may take the form of a portal, or host web site, attached to the Internet that consumers 134 may access through user interface devices 130.

Central controller 110 preferably comprises a processor based system that maintains databases and information relating to web sites that consumers have requested information for and the update schedules and other information relating to those web sites, along with, but not limited to, the personal information and interests of those consumers requesting information about web sites. A web site update schedule is a schedule that maintains items such as the times at which a particular web site plans to next update or change the content of its site, the history of changes made to the content of the site, such as when the site was last updated, and possibly a prediction of when the site will next make changes to its content.

As described more fully below, a consumer may request the update schedule for a particular web site from the system shown in FIG. 1 and the system stores information related to the consumer and the web site and provides the consumer with the update schedule, along with other information, that the system receives and/or obtains from the web site or had received and/or obtained from the web site previous to the request and had stored in a database.

Central controller 110 provides the graphical user interface (GUI) to consumers 134 at user interface devices 130 which allows consumers to request update schedules for one or more web sites, such as web site 124. In one embodiment, user interface device 130 may be a computer comprising one or more central processing units, one or more data storage devices, a monitor, a keyboard and/or any other components that may allow a user to implement the commands of the software and hardware functions described herein.

Central controller 110 stores information received from consumers 134 in consumer database 260, web site schedules database 270 and interest database 280. As described more fully below, this information is used to receive requests for web site update schedules from the consumer 134 and provide those schedules to the consumer. Moreover, by monitoring consumer request history, central controller 110 may provide consumer 134 with advertisements and promotions that may be of interest and recommend other web sites to the consumer that may be of interest to them. Also, the central controller 110 maintains a database of the update schedules of the web sites for which various consumers have requested information. Central controller 110 may obtain this update schedule information through various means including, but not limited to, receiving the information as it becomes available directly from web sites 124 that have previously registered with the central controller 110 through the interface device 120, by predicting the update schedule of the web sites 124 based on the previous history of the web sites 124 update schedule, by predicting the update schedule of the web sites 124 from information gathered from the content of the web sites 124 themselves, or from crawling the web sites 124 periodically through interface device 120 to obtain and compare the content of the web sites 124 to determine the last time that the web site 124 had updated its content.

Consumers 134 include individuals wishing to obtain the update schedules of one or more web sites connected to the Internet. In one embodiment, consumers 134 register with the central controller 110 through user interface device 130, select those web sites that they would like to receive update schedule information for every time that they use the system, and/or request update schedule information for a particular web site for one time viewing. In one embodiment, the user interface device 130 may be the consumer's computer or Internet access device. Consumer 134 can transmit update schedule requests electronically by means of the Internet. This is done by completing registration and update schedule request pages electronically from the user interface device 130 to the central controller 110, which provides a consumer interface in the form of a web page on the internet.

Central controller 110 receives all consumer information, monitors consumer demographics, and executes update schedule requests. Some web sites 124 may provide update schedules, along with, but not limited to, advertisements and promotions, through interface device 120 to central controller 110. In one embodiment, other web sites 124 might not transmit any information to central controller 110 and, in that case, the controller 110 may obtain the update schedule and/or other information from these sites by visiting these sites itself through interface device 120 and analyzing and/or comparing the content of those sites. In one embodiment, central controller 110 transmits and receives information to/from web sites' 124 server electronically by means of the Internet.

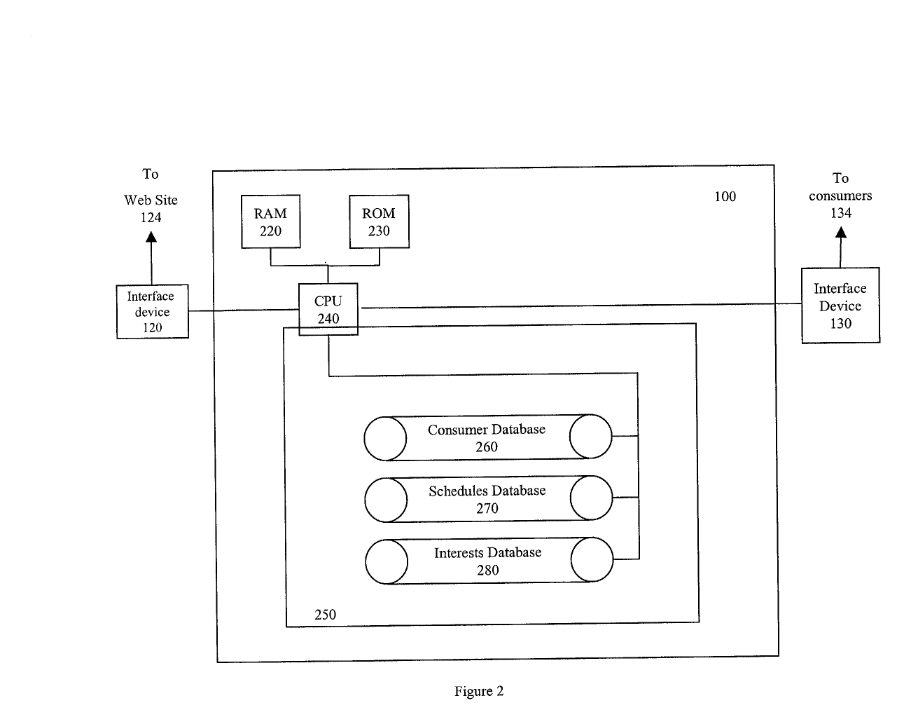

FIG. 2 illustrates one embodiment of the central controller 110 for a system according to the present invention. As shown in FIG. 2, central controller 110 includes central processing unit (CPU) 240, random access memory (RAM) 220, read-only memory (ROM) 230, and large capacity storage device 250. CPU 240, preferably comprising a conventional microprocessor such as an Intel Pentium Processor, is electronically coupled to each of the central controller's 110 other elements.

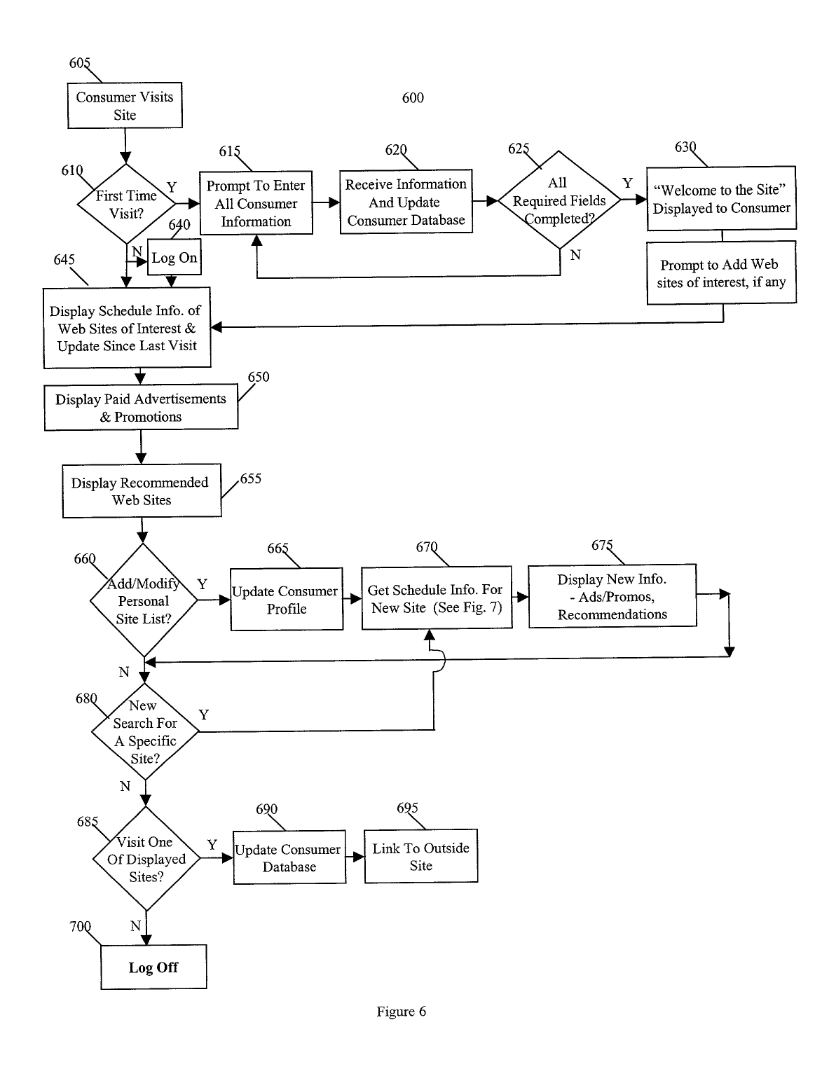

CPU 240 executes program code stored in one or more of RAM 220, ROM 230 and storage device 250 to carry out the functions and acts described in connection with central controller 110. CPU 240 preferably comprises at least one high-speed digital data processor adequate to execute program modules for, among other things, executing requests web site update schedules made by consumers 134, for executing update schedule changes made by web sites 124 and for executing maintenance of the update schedules database 270. These modules are described in connection with FIGS. 6-10. CPU 240 interacts with RAM 220, ROM 230 and storage device 250 to execute stored program code according to conventional data processing techniques.

User interface devices 120 and 130 comprise devices for allowing central controller 110 to communicate with web sites 124 and consumers 134. Communication between these user interface devices 120 and 130 and the controller 110 is preferably electronic by means of the internet and preferably includes a conventional high speed modem, or some other device, employing known communication protocols capable of decrypting encrypted data received from the user interface devices 120 and 130.

Large capacity storage device 250 contains consumer database 260, web site schedules database, 270, and interests database 280. In the embodiment demonstrated in FIG. 2, data in said databases is maintained, determined and accessed by CPU 240. Another possible embodiment may comprise a separate, conventional CPU/microprocessor to serve as a transaction processor. The data is used to prepare update schedules, along with, but not limited to, advertisements, promotions and other recommended web sites, for transmission to consumers 134 in response to requests for a said web site update schedule as described in connection with FIGS. 6-10.

Consumer database 260 contains data about consumers 134 that register with the host web site. The data is used to execute the request for an individual web site update schedule, to provide the update schedules on every subsequent visit to the host site of those web sites chosen by the consumer 134 to have as much (those on the consumer's 134 web sites of interest list 360), as well as, but not limited to, transmitting targeted information of potential interest to the consumers 134.

The web site schedules database 270 contains information about the update schedules of each of the web sites that the host system keeps track of, along with the interest categories that the site falls under, and any advertisements or promotions that the site wishes to have transmitted to the consumers 134.

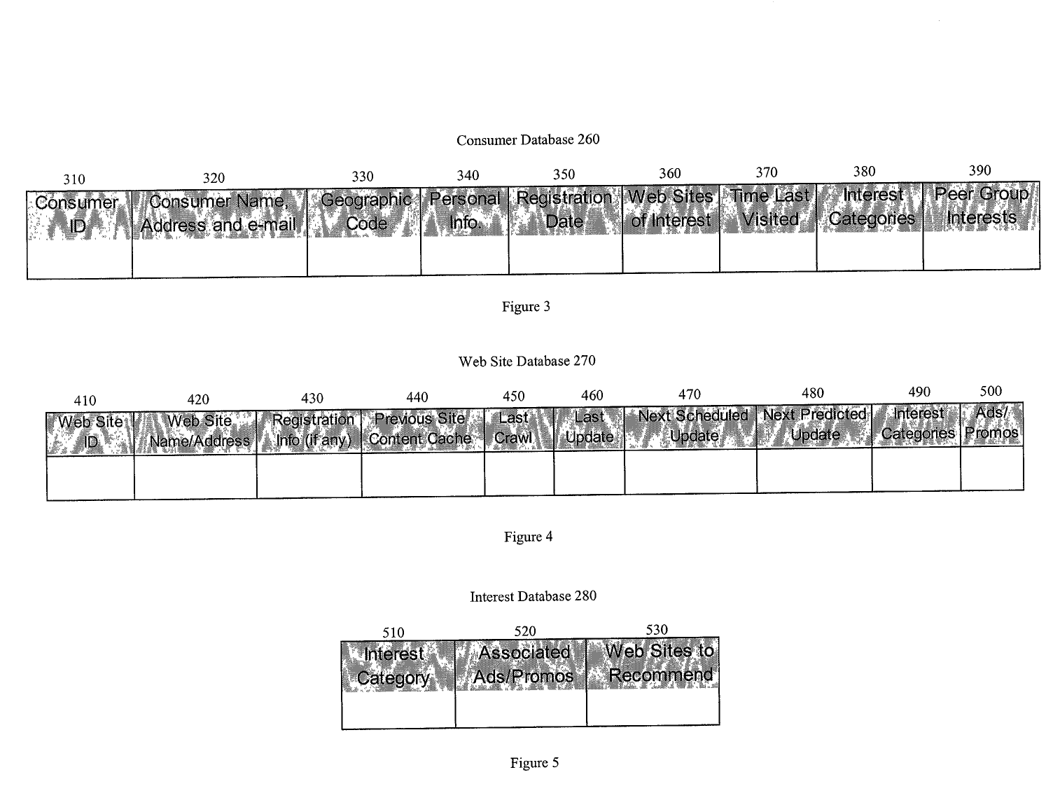

The interests database 280 contains information relating to the interest categories under which the consumers 134 and web sites 124 may fall. This database may contain advertisements, promotions or web site recommendations that are targeted for, and are to be transmitted to, the consumer 134 based on the interest categories that said consumer falls. Samples of the respective fields contained in databases 260, 270 and 280 are shown and described in connection with FIGS. 3-5.

Database Formats

Samples of the contents of databases 260, 270 and 280 are shown in FIGS. 3-5, respectively. The specific data and fields illustrated in these figures represent only one embodiment of the records stored in the databases of the invention. In most cases, the fields shown in FIGS. 3-5 are self-explanatory. It is to be understood that the data and fields, as well as the number of databases, can be readily modified from the described embodiment and adapted to provide variations for operating the system and method described. Furthermore, each field may contain more or less information. For example, an address field may be divided into separate fields containing street address, apartment number, city, state, zip code, telephone number and e-mail.

Consumer database 260 maintains, among other information, a compilation of all information provided by each consumer 134 in response to a series of prompts (fields) provided to the consumer 134 via user interface device 130 during a registration process that will be more fully explained in connection with FIGS. 6-10. In one embodiment, the consumer enters the information into fields of a web page. Each record in consumer database 260 corresponds to one consumer.

FIG. 3 illustrates a sample record. As shown in FIG. 3, consumer database 260 contains fields corresponding to, for example, consumer ID, consumer name, consumer address, e-mail address, personal information (which may include a password, consumer profession, title and interests), geographic code, registration date, an array, or list, of the web sites that the consumer is interested in (those that the consumer desires to repeatedly have the update schedule information for every time that they log on to the host site—i.e., the personal site list), an array, or list, corresponding to the web site list that contains the times of the consumer's last visit to each of the sites on the personal site list, the interest categories that are obtained by an analysis of the sites on the consumer's personal site list and those interest categories that other consumers fall under who have the same interests (are in the same peer group) as the current consumer. The data that is retrieved directly from consumers' answers to prompts on a web page include the consumer name, consumer address and e-mail address, any personal information and the web sites to be placed on their personal site list.

Many of the fields illustrated in FIG. 3 are self-explanatory. The geographic code 330 is a code grouping consumers by location—i.e., “NE” for northeast USA, international country codes, etc. The registration date 350 is the date a consumer registered with the on-line store. The web sites of interest field 360 (personal site list) is a list of the web sites that the consumer supplies to the host site. Every time the consumer logs on to the host web site they can see this list of web sites displayed to them, along with the update schedules of these sites, which informs them of the next time that these sites will update with new content, if possible to tell, and whether or not the sites have updated since the consumer has last visited them. The other fields will be described more fully below, in conjunction with FIGS. 6-10, and as will be discussed, the geographic, personal information and web sites of interest information is collected and monitored so that advertisements and promotions, as well as other recommended web sites, may be targeted to specific consumers who may be interested in them.

The password provided by consumer 134 is any word or characters known to consumer 134 but not known to the general public and is used to prevent others from logging in under the consumer's user ID. The central controller 110 uses the password to verify that the consumer using the host site is in fact the same consumer who initially registered with it. From the data described and the data stored in other databases, the data from the remaining fields can be generated.

Web site schedules database 270 contains information about the various web sites, along with information about their update schedules, that have either been selected by consumers as those sites for which they want to have the update schedules or those sites that have registered with the host site themselves to provide their update schedules to it. As will be discussed more fully below, web sites may be motivated to independently register with the host site in order to take advantage of the consumer information that the host site maintains. As shown in FIG. 4, web site schedules database 270 contains fields needed to keep the consumers 134 as up to date on the update schedules of the various web sites as possible. Other fields exist to maintain the interest categories that the web sites fall under so that they may be recommended to consumers who may have an interest in them, as well as keep track of any advertisements or promotions that a web site may want displayed to particular consumers. All the fields are discussed in detail below with reference to FIGS. 6-10.

Interest database 280 contains information about the advertisements or promotions that may have been sold and that are to be targeted to specific consumer groups, as well as web sites that may be recommended to consumers based on the interest categories in which a consumer may fall. FIG. 5 illustrates these fields, which will be discussed more fully below. The data in interest database 280, as well as consumer database 260 and web site schedules database 270, are updated routinely.

The process, according to one embodiment, of using data from consumer database 260, web site schedules database 270 and interests database 280 to provide web site update schedules to those consumers 134 who wish to see them, along with information targeted to the consumer 134, as well as the other operations of the system described with reference to FIGS. 1 and 2, is represented in the flowcharts of FIG. 6-10, described in detail below.

Central controller 110 uses consumer database 260, web site schedules database 270 and interest database 280 along with the interface devices 120 and 130 to execute the various process that make up the system of the invention. In the descriptive embodiment of the invention these processes include: a consumer registration process; a consumer use process; a web site registration process; a web site use process; a process for accessing the update schedule for a new web site; a process to add a web site to the web site update schedules database 270; and a process for maintaining the web site update schedules database 270. These processes are originated either from contact by one of the user interface devices 120 and 130 or from within such processes. Each of the following processes could be accomplished in alternate means and the invention itself could also be comprised of more or less processes than described here.

Consumer Registration Process

The consumer registration process is the process that a consumer 134 undergoes the first time that they visit the host web site or to update user registration information. This process is responsible for, at least, obtaining the personal information of the consumer, compiling the list of the web sites that the consumer desires schedules for, creating a space for the consumer in the consumers database 260 and obtaining the interest categories that correspond to the content of the web sites that the consumer has chosen.

Referring to FIG. 6, the consumer 134 contacts the web site of the host system (step 605) via user interface 130. The consumer is then asked if this is their first visit to the site (step 610). If it is, then the consumer registration process begins (step 615), if it is not, then the consumer logs on to the site (step 640) and begins the consumer use process that will be explained more fully below. Returning to step 615, controller 110 then prompts consumer 134 to enter all of the required fields to undergo the registration process. These fields correspond to many of the fields of the consumer database. The consumer must provide: a consumer ID, or login name, 310; their full name, address and e-mail address 320; personal information 340, such as occupation, title, interests, and a password to be used for login (in some embodiments fulfillment of the personal information fields may be optional, in others they may be mandatory—it would be desirable to have such information for demographic targeting purposes, but some consumers may be reluctant to provide it—excluding the password which will always be mandatory). The consumer will then submit their data to the host site, which the controller 110 will receive and use to create a new entry in the consumer database and fill with the entered data (step 620). The central controller 110 will then check if the consumer has completed all of the required fields (step 625). If so, the consumer will then be welcomed to the site (step 630), if not, the consumer will then be re-prompted to enter the missing required information (return to step 615) and steps 615-620 will be repeated until the consumer has filled in all the required information. After the consumer 134 is welcomed to the site, the controller 110 will then use the information the consumer provided to automatically generate the geographic code 330 based on the consumer's supplied address 320 and fill in the registration date 350 which would correspond to the current date and time.

At this time, the consumer 134 is then prompted by controller 110 to enter the names of any web sites that the consumer wants added to their personal site list (step 635). This site list will be stored in the consumer database web sites of interest 360 data field. This personal site list becomes the focal point of the embodiment. Any subsequent time the consumer logs on to the host site, this personal site list will automatically be displayed along with the update schedule information for all of the sites on the list. The update schedule information for one particular site on the personal site list may comprise, for example, of the time the consumer had last visited that site, if the content on the site has been updated since the consumer's last visit, the time of the next scheduled future update or the prediction of such time. The personal site list will also be used to generate the consumer's interest categories data list 380 based on the interest groups under which the content of the sites that the consumer has chosen to become part of his personal site list falls. For example, if the consumer has chosen to add “espn.com” to their personal site list, then one of their interest categories correlating to that site would be “sports.” An interest category could be obtained from every site that the consumer chooses, and some sites may fall under several different interest categories. The interest categories 380 may be made up of interests that are obtained in this manner and also from any interests that the consumer had chosen themselves during the registration process and stored in their personal information field 340. The interests categories 380 may be used to generate a selection of advertisements, promotions, and recommended web sites that are to be displayed to the consumer. One of the interests of the consumer listed in the interests categories 380 may also be selected. That interest will correspond to one of the interests listed in the interest category 510 data field in the interest database 280. The interest may have corresponding advertisements and promotions associated with it, along with a list of web sites that correspond to said interest. Then, when the web site update schedules are displayed to the consumer, advertisements, promotions and other recommended web sites that are based on the consumer's interests will also be displayed to them. In this manner, a consumer will generally only see material corresponding to those topics that are of interest to them, and then valuable advertising space will not be wasted on consumers who are likely to ignore the material.

Another method of creating interest categories, other than the ones corresponding to the web sites that users have chosen to become part of their personal site list and the ones that they have chosen themselves, is by basing the interests of said consumer on the interests of other consumers that have similar interests as the instant consumer, i.e. the collaborative filtering approach; whereby interests for the consumer are adopted from other like-minded consumers who make up the consumer's peer group, where the peer group is formed based on each consumer's interest categories 380. For example, consumer 1 has interests in “fishing,” “hunting” and “cooking.” Consumer 2 has interests in “fishing,” “hunting” and “auto racing.” Consumer 1 and 2 could become part of the same peer group because they have 2 similar interests (hunting and fishing). Consumer 1 could then have added in his/her consumer database peer group interest field 390 an entry for “auto racing” because it is an interest that a member of his/her peer group has that he/she does not. Likewise consumer 2 could have “cooking” added to their peer group interests 390. Consumers 1 and 2 could then receive advertisements, promotions, and web site recommendations related to auto racing and cooking, respectively, even though they had never shown any interest in such activities. In this manner it is possible to widen the number of interest topics that a consumer is exposed to, but also keep a relation between what the consumer sees with what they may be interested in, thereby decreasing the likelihood that the consumer ignore the material offered to them altogether. Of course the number of interests that are used to create the peer group could be increased from two, as used in the example, to create a more personalized peer group. The number of members in the group will decrease, but the likelihood that a consumer will actually be interested in the peer group interests 390 that are generated for them will increase.

Once the consumer 134 has finished creating their personal site list and the central controller 110 has added the list to the consumer database, along with the interest categories 380 and the peer group interests categories 390, possibly in the manners described above, the central controller then displays the web site update schedule information for the chosen web sites to the consumer (step 645). This step is the same step following logon (step 640) for a consumer already registered with the system who visits the host site, as described above, and thereby completes the registration process. The remaining steps in FIG. 6 relate to the consumer use process and will be described below.

Consumer Use Process

The consumer use process begins in the same manner as the consumer registration process. Referring to FIG. 6, a consumer 134 contacts the host web site (step 605) via user interface 130, and is asked if this is a first time visit (step 610). If it is, then the consumer proceeds to the registration process (step 615-630) as described above. If it is not, then the consumer logs on to the host site (step 640) using consumer ID 310 and password contained in the personal information field 340, and the consumer use process begins.

First, the update schedule information for each of the web sites on the consumer's personal site list is displayed (step 645). This information, as described above, may consist of the consumer's last visit to the site, whether or not the site has been updated since that last visit, and to tell the time of the next future scheduled update or a prediction of that time.

Next, advertisements or promotions are displayed to the consumer (step 650). There can be at least two types of advertisements or promotions available to be displayed. Some web sites that have registered with the host site may have particular advertisements or promotions that they want displayed any time any consumer requests that site's update schedule. These advertisements are independent from any advertisements that may be associated with the consumers interest categories 380, and are displayable to any consumer that has requested that site's schedule regardless of that consumer's interests. These advertisements are represented in the web sites schedules database 270 as advertisements/promos 500 in FIG. 4 and are discussed further in conjunction with FIGS. 8-10 and the web site use/registration processes.

The other types of advertisements and promotions are those that are to be displayed to consumers based on their interest categories 380 and their peer group interests 390. The creation of these data lists was discussed above in the consumer registration process. To display an advertisement or promotion based on the consumer's interests categories, an interest must be selected from one of the fields. This interest may be picked at random or in any other manner, such as that the most repeated interest is to be selected. This interest is then found in the interests database 280, interest category 510 data field. Any interest selected will be found in this field because any time a new interest is detected by the system, either through an input from a consumer, from the content of a new web site or from the content of a new advertisement, this interest will be added to the interests database 280.

Then, any advertisement or promotion that is sold to an outside vendor that corresponds to that interest is placed in the interests database 280 associated advertisements/promotions data field 520 and any web site that is added to the web site schedules database, either through a consumer request or a web site self-registration, as will be discussed more fully below, that corresponds to that interest is added to the web sites to recommend 530 data field in the interests database 280. When the particular interest category that has been chosen is located in the interest category 510 data field by the controller 110, those advertisements and promotions 520 that correspond to that interest may then be displayed to the consumer. Further any web sites that are to be recommended in the interests database 280 that correspond to the chosen interest will then be displayed to the consumer 134 (step 655).

The following example illustrates the above process. Assume a consumer with a personal site list 360 consisting of “espn.com” and “thepatriot.com” (a movie site). The consumer's interest categories may consist of “sports” and “movies,” while a peer group interest may be “cigars.” When the consumer logs on to the site, they will see the update schedule information for “espn.com” and “thepatriot.com” which may look like:

| | | Updated Since | Next |
|---|---|---|---|
| Site | Last Visited | Last Visit? | Scheduled Update |
| espn.com | 6/7/00 13:22:04 | Yes | 6/10/00 06:00:00 |
| thepatriot.com | 6/5/00 10:09:53 | No | 6/12/00 03:00:00 |
| | | | (predicted) |

In addition to a display such as this, the consumer may also see some advertisements and recommendations. Assume also that “thepatriot.com” has an associated ad/promo 500 in web sites schedules database 270 that offers a free T-shirt, any consumer who has added “thepatriot.com” to their personal site list 360 will receive this offer. Additionally, the consumer will also receive information based on one of their interest categories 380 or peer group interests 390. If “cigars” happened to be chosen from one of the three choices, then the consumer may see an advertisement for “Half-Price Panamanian Cigars” from “discountcigars.com” that that site may have paid the host site to display to anyone with an interest category of “cigars.” Furthermore, the consumer may see a recommendation to visit the site “cigarafficianado.com” along with site reviews, for example.

This method of providing advertisements and site recommendations to consumers also provides some incentive for outside web sites to register with the host site to provide their update schedule information to the host site. In exchange for this schedule information, the host site can agree to display the associated advertisements/promos 500 that the outside web site wants displayed whenever a consumer requests their schedule information. Additionally, the host site can agree to place any registered web site in the web sites to recommend 530 data field in the interests database 280 so that when a consumer requests the update schedule for a web site with similar content as said registered site, a recommendation and link to said registered site will also be displayed, thereby increasing the chances that consumers may visit that site and increasing the traffic to the site. As will be discussed more fully below, such incentives are important because self-registration by outside web sites make the invention more efficient, accurate and reliable, and also frees up needless traffic on the outside web sites that choose to self-register by negating the need for the system to periodically crawl the outside web sites to obtain the update schedule in alternate means.

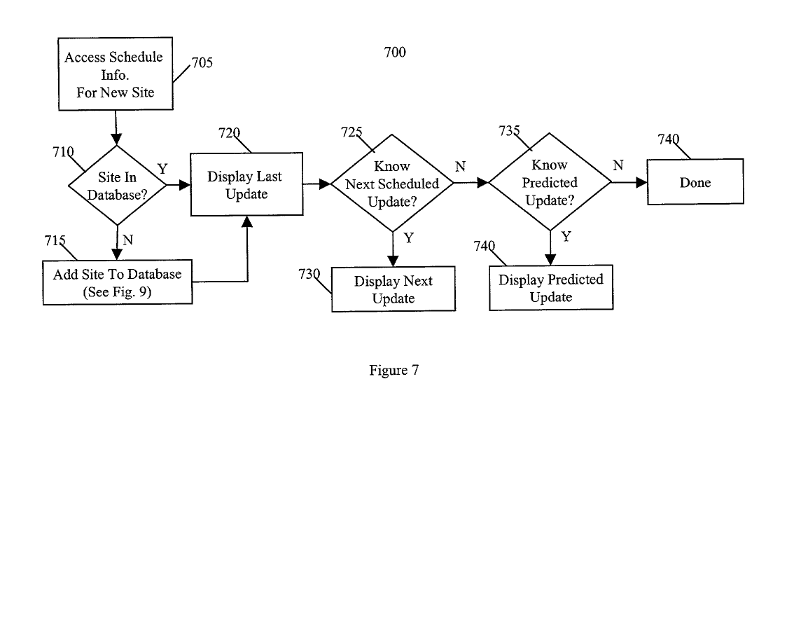

Continuing with FIG. 6, once the consumer 134 sees their original personalized display, they then have several options. The controller can sense if the consumer chooses to add sites or otherwise modify their personal site list (step 660). The host site display can have a feature that allows the consumer to do this in any number of ways: in a data entry field on the main display or with a link to a different page on the host site that is dedicated to this step, for example. If the consumer takes this action the controller 110 will then update the consumer profile to correspond to these changes (step 665). This will involve updating the consumer's web sites of interest 360 and may also affect the consumer's interest categories 380 and peer group interests 390 as appropriate. Any sites that the consumer adds to their personal site list in this manner will then automatically be displayed with that site's update schedule information any future times the consumer logs on to the host site as described above. After updating the consumer profile, the controller 110 will then get the update schedule information for the new site and display it to the consumer (step 670). This step will be discussed in detail in conjunction with FIG. 7. The next step involves displaying to the consumer any new advertisements, promotions, or site recommendations that may be appropriate (step 675), in the same manner as that described above. The steps for modifying the consumer's personal site list are now complete.

At this point, whether or not the consumer chose to modify their personal site list, they then have the option of accessing the update schedule information for a particular web site that they do not want added to their personal site list. The consumer may use this feature if they are interested in the update schedule for a particular web site for a one-time event, for example, but do not want to see the update schedule for that site every time they log on to the host site. The controller 110 can detect if the consumer chooses this option (step 680). If the consumer does so, the controller 110 then undergoes the same process as if the consumer modified their personal site list, except not updating the consumer's profile, by proceeding to access and display the update schedule information for the new site (step 670), which will be described below. It may also be desirable for the controller 110 to store information relating to a consumer's search history for demographic purposes in a new field in the consumer database 260. The controller 110 will then display any advertisements, promotions or site recommendations as appropriate (step 675). Since the consumer profile was not updated to reflect this particular web site for which a schedule was obtained, the consumer 134 may not have his interest categories 380 reflect the interest content of this particular site. In such circumstances, it may be desirable to have the interest that is used to look up advertisements, promos and recommendations in the interests database 280 to come from the web site's interest categories 490 itself as opposed to the consumer's interest categories 380. Thereby, material relating to a new interest that may not be reflected in the consumer's interest category 380 profile that they nonetheless may be interested in (as evidenced by their desire to search for an update schedule of a web site with content corresponding to that interest) may be exposed to them. After receiving the display information relating to the particular update schedule search, the controller 100 will then detect if the consumer 134 wants to conduct another search of this type. If so, this process can continue repeatedly until the consumer no longer desires additional individual searches.

Of course, while not diagrammed in FIG. 6, a consumer may also modify their personal site list any number of times during a visit to the host site, but it is more likely that a consumer will search for individual sites repeatedly than it is for a consumer to modify their personal site list repeatedly in any given visit to the host site. Thus, for simplicity, FIG. 6 has been diagrammed in the exemplified manner.

Once the consumer has completed searching for the update schedule's of individual sites, the consumer may then visit, through a link, for example, any of the web sites whose schedules have been displayed to them (step 685). Additionally, the consumer may also visit one of the advertisements, promotions or recommended sites that was displayed to them.

If the consumer chooses to visit one of the sites that make up part of their personal site list, the central controller 110 will update the time last visited 370 data field in their consumer profile that corresponds to the site that they have chosen to visit with the current date and time (step 690). This allows the host site to keep track of the times that the consumer has visited this particular site in order to more accurately inform the consumer of whether or not the said site has updated since the consumer's last visit to that site the next time that the consumer gets the update schedule information for that site. This also provides a motivation for consumers to access their favorite sites through the host site and use the host site more frequently, ideally as their main portal to the Internet.

If a consumer were to access a particular site without going through the host site, then the host site would be unaware of the time of the consumer's true last visit to that site. When the consumer then receives the update schedule information for that site, the consumer may also receive inaccurate information as to whether that site has actually been updated since their last visit. A desire to avoid this annoyance may lead the consumer to use the host site most frequently. After updating the consumer's profile, the controller 110 will then link the consumer to the outside site that they have chosen (step 695). If the consumer chooses to not visit any of the links, then they simply log off of the system (step 700).

Getting the Update Schedule for a New Site

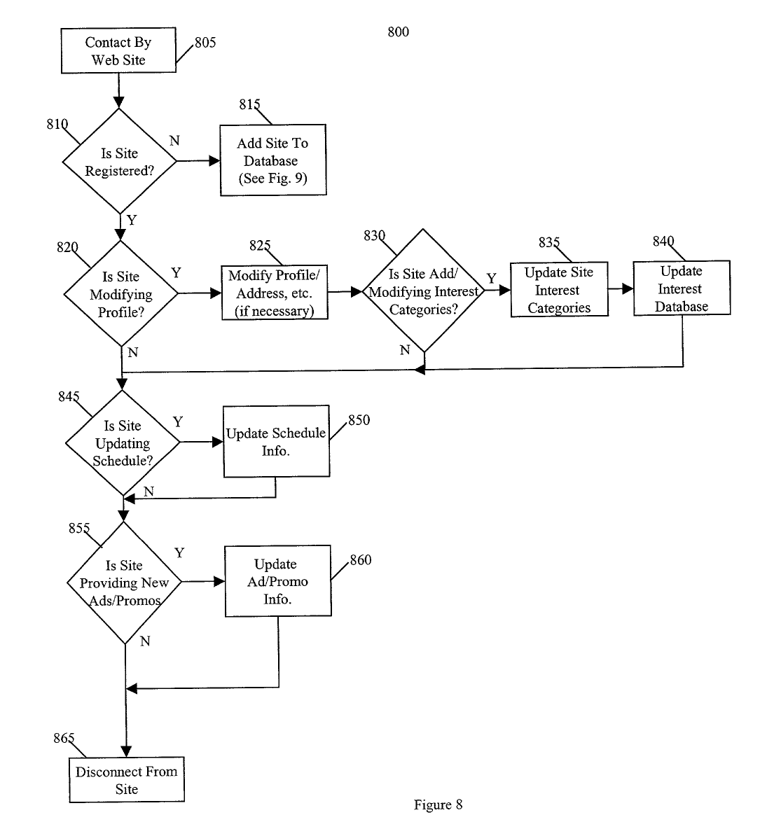

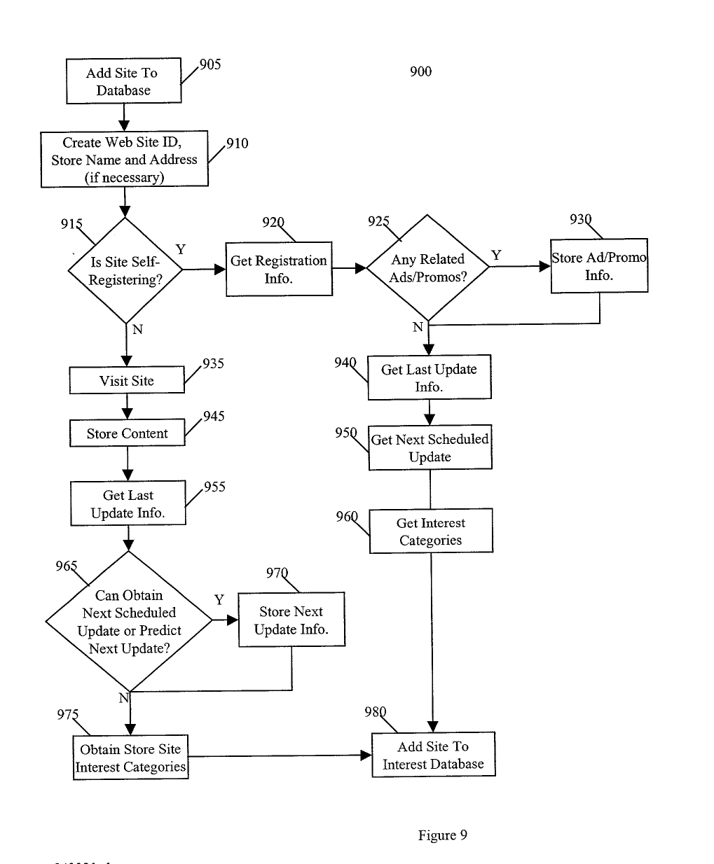

As described above, a consumer may wish to see the update schedule for a web site that was not on his personal site list when he first logged on to the host system. The process of obtaining this schedule is shown in FIG. 7. The central controller 110 first accesses schedule information for the new site and determines whether or not the desired site is already in the web site schedules database 270 (steps 705 and 710). If the site is not in the database then it is added (step 715). This process is explained below in conjunction with FIG. 9.

Adding a site to the database of update schedules 270 every time that a consumer requests the update schedule for that site if it is not already in the database allows the system of the invention to amass a large number of web sites that the system may access the update schedule for quickly and easily. This will allow other consumers who may request these sites to obtain their update schedules more quickly and also allow the system to keep track of those sites that consumers in general may be interested in and the popularity of those sites based on how many times an update schedule is requested for a site.

If the site is already in the web site schedules database 270, then the controller 110 merely accesses the entry in the database corresponding to that site. At a minimum, the entry will contain a time for the last update of that site, as will be described below, this information is displayed to the consumer (step 720). The controller 110 cannot inform the consumer if the site has updated since the last time the consumer has visited the site because the controller is not aware of that time, this is the first time that the consumer is requesting the update schedule for this site—it is not part of their personal site list.

The entry in the schedules database 270 for the particular site being displayed may also contain the next scheduled update 470 of that site (step 725). If it does, then this information is displayed (step 730) and the process is complete. There are various methods by which the system may obtain this information—either by receiving it directly from a registered web site or by determining it from the content of the site directly during a crawl, such as from a news site that announces its next update time—but for some web sites it may be impossible to tell. In those cases, the information will not be displayed and the controller 110 then checks to see if the next predicted update 480 for the particular site being displayed is known (step 735). If it is, it is displayed (step 740) and the process is complete. It may be possible to predict the update schedule for a particular web site based on an analysis of the content of the site obtained during various crawls. For example, if a site has historically updated daily at 7:00 a.m., then it may be predicted that the next update will be the next day at this time. In these cases, the site has not announced that this will happen, and the prediction may be wrong, but it is better than providing no information to the consumer. If this information is also unknown, however, then the process finishes (step 740) with only having provided the time of the last update for that site to the consumer.

Web Site Registration Process

As described above, it is desirable for various outside web sites to register directly with the host site to provide its update schedules to the system. If a web site does not do this, then the host system will begin a periodic crawling process of the outside site to try and determine the update schedule of the web site itself at any time that a consumer requests the update schedule for that site. This crawling process, which may add unnecessary traffic to the web site, may continue indefinitely. Having sites registered with the host site provides benefits for both the host system and the outside web site. The host site can bypass the inefficient and expensive process of crawling the outside sites to determine their update schedules, which will free up resources for the host site to deliver results more quickly to the consumers, and the accuracy of the update schedules will also be increased if the outside sites provide them to the system themselves, which should also lead to increased customer satisfaction. For outside web sites, one advantage of registration includes avoiding the crawling process that will necessarily ensue if they do not register. Registration also permits targeting more information to potential visitors who may be more inclined to visit a particular site if they know that the content is new, being allowed to provide advertisements or promotions 500 that will be displayed along with their update schedule to those consumers who request it and being recommended to consumers who may have an interest in the content of their site and may nevertheless not be aware of the site.

The web site registration process begins when a web site 124 contacts the host system (step 805) through the user interface device 120 as shown in FIG. 8. The host determines whether the contacting site is already registered or not (step 810). The controller 110 can do this quickly by checking the registration information 430 data field in the web site schedules database 270. If this field is empty or if this web site has no entry in the schedules database 270 altogether, then this site is not registered with the system. For the registration process, the web site will not already be registered, so the controller must then add the site to the web site schedules database 270 (step 815). This step, along with the remainder of the web site registration process will be described below in conjunction with FIG. 9. If it is determined in step 810 that the site is already registered with the host, then the controller 110 proceeds to the web site use process by moving on to step 820.

Web Site Use Process When a web site 124 that has already registered with the host system wishes to use the system—either to provide a new update schedule, modify its profile or provide new advertisements or promotions—it must first contact the host site (step 805) through the interface device 120 as shown on FIG. 8. This is the same process as when a web site 124 registers with the host system except that the controller 110 determines that the site is already registered (step 810) and determines those actions that the site wishes to undertake. The controller 110 checks if the web site wishes to modify its profile (step 820). If so, the controller will update the web site's profile in the web site schedules database 270 to reflect any changes that the site may want to make to its name, internet address 420 or its registration information 430 (step 825). The controller then checks if the web site is modifying or adding to the interest categories 490 that it believes it falls under (step 830). In the exemplified embodiment, a change to a web site's interest categories 380 constitutes a change to the site's profile as questioned in step 820, so even if the site is not changing its name, address or registration information that would be updated in step 825, the controller still proceeds to step 830 to make this interest inquiry. If the site is changing its interest categories, this change will be made by the controller 110 in the interest categories 490 field in the schedules database 270 (step 835). The interests database 280 is then also updated to have this web site 124 added to, or removed from, the sites to recommend 530 field of the corresponding interest category 510 entry that matches the new, or old, interest that the web site falls under (step 840).

Following this step (or if there were no interests categories to modify), the controller then checks to see if the web site is providing a new update schedule (step 845). If it is, the appropriate field is updated in the schedules database 270 (step 850). Most often this will be the next scheduled update field 470. With this step completed, or if the site was not providing a new update schedule, the controller 110 then checks if the site is providing any new advertisements or promotions to be associated with the site (step 855). If it is, the advertisements/promos 500 field in the schedules database will be updated to reflect this. Now, when a consumer requests the update schedule for this site, they will also have displayed to them the advertisement or promotion 500 that the web site had just supplied to the host system. Following this step, or if the web site did not provide advertisements or promotions or if the site took no actions at all, the web site is then disconnected from the host system (step 865).

Adding a Web Site to the Schedules Database

As described above, at times a new web site 124 must be added to the web site schedules database 270. Under the described embodiment, there are two ways in which this process can be originated: if a consumer 134 requests the update schedule for a particular web site (either by adding it to their personal site list 360 or by doing an individual search for that specific site's update schedule (step 680)) and there is no entry for that site in the schedules database 270—then it is added (step 715); or if a web site 124 contacts the host system and is not already registered (step 810), then it is trying to register with the system and is added to the schedules database (step 815).

FIG. 9 demonstrates the process of adding a web site 124 to the schedules database 270. The first step is to create a web site ID 410 for the host system to be able to identify the site and to store the name and Internet address 420 of the site in the database 270 (step 910).

In the present embodiment, during this step there may be some situations in which this information may already be in the schedules database 270 and this step may be skipped. This situation will arise if a consumer had requested the update schedule for a particular site that was not already in the schedules database 270, and therefore the site was added to the database 270 under a non-self-registering profile (step 915) from step 715, and then, at a later date, the same web site chooses to register with the host system itself. It is then sent through the add-to-database process 900 again, but this time under a self-registering profile (step 915) from step 815. This second time through the process, any information that was stored in the schedules database 270 the first time through, with the exception of the web site ID 410 and the name and address 420, is overwritten by more accurate self-registering information, so it is completely appropriate for the web site to go through the same process 900 again because the only repeated step is 910 and the controller 110 can skip this step if that information has already been completed for a particular web site 124.

After completing step 910 (if necessary), the controller 110 determines if the site is self-registering or not (step 915). If the site is being added in response to a request for an update schedule from a consumer 134 (from step 715) then the site is not self-registering. If the site is being added in response to its own contact with the system (from step 815) then it is self-registering.

In the latter case, the controller 110 first accesses any necessary registration information from the web site 124 and stores it in the schedules 270 database in the registration information 430 field. The controller 110 then determines if the web site 124 is providing any related advertisements or promotions that are to be displayed whenever a consumer requests the update schedule of the site (step 925). If so, this information will be added to the advertisements/promos field 500 (step 930).

When completed, or if there were no advertisements or promotions, the controller 110 then accesses the time of the site's 124 last update and store it in the last update field 460 (step 940) and the time of the site's 124 next scheduled update and stores it in the next scheduled update 470 field (step 950). The controller 110 then accesses the interests that the site 124 categorizes itself as falling under and these will be added to the interests categories 490 field (step 960). These interests are then added to the interests categories 510 of the interests database 280, if not already entered, and the site 124 is added to the web sites to recommend 530 for each of those corresponding interest categories 510 that the site 124 falls under in the interests database (step 980).

If the web site 124 is not self-registering then the system of the invention begins the crawling process for the site. This process entails visiting the site (step 935), storing the necessary content (step 945) and accessing the most up to date information (step 955). Central controller 110 then determines whether the next scheduled update can be obtained or predicted (step 965). If it can, the update information is stored, the store site interest categories are obtained and the site is added to the interest database (steps 970-980). Otherwise, no update information is stored, but the store site interest categories are obtained and the site is added to the interest database (steps 975-980).

Maintaining the Web Site Schedules Database

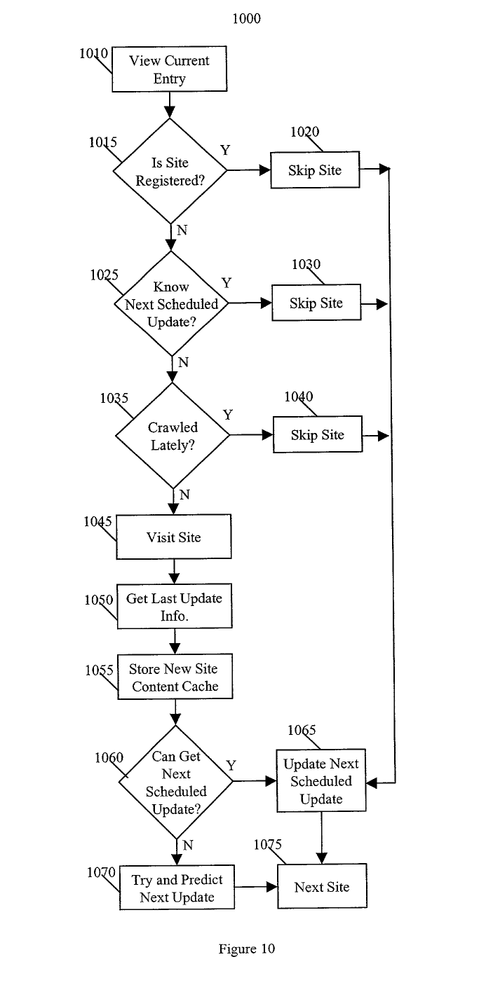

The system of the invention also obtains the update schedules of those web sites that are not registered with the system. In the present embodiment, that task is completed primarily by crawling the various web sites and analyzing their content. This can be accomplished during the system's idle time while neither consumers 134 or web sites 124 are contacting the host site through interface devices 130 or 120. During this phase the system goes through the process of maintaining the schedules database. FIG. 10 illustrates this process.

The controller 110 cycles through all the entries in the web site schedules database 270 one at time. The process begins by viewing the current entry in the database 270 (step 1010). If the web site 124 in that entry is registered with the system (step 1015) then that entry is skipped (step 1020). There is no need to crawl sites that have registered with the system because they will provide the update schedule information to the system directly. If the site is not registered, the controller 110 checks to see if the next scheduled update 470 is known for the site in that entry (step 1025).

Even though a site may not be registered with the system it may still be possible to know the next scheduled update of that site through several means. For example, many news sites state the time of their next update directly on their sites. If the next scheduled update 470 is known, then the controller skips that site (as long as that date has already passed) (step 1030). If the next scheduled update 470 is not known, then the controller 110 checks to see if the site has been crawled recently via the last crawl 450 data field (step 1035). There is no reason to re-crawl a site that has been recently visited, so if it has, then that site is skipped (step 1040). The threshold for what amount of time will constitute “recently” can of course be varied in different embodiments of the invention depending on the needs and resources of the system and the number of web sites in the schedules database 270. In the steps previously described in which a site was “skipped,” what is meant is that that entry in the schedules database 270 will be bypassed by the controller 110 because that site does not need to be crawled during this pass of the database and the next entry in the database will be analyzed instead. If a site has not been crawled “recently”, then the system will visit that site through interface 120 (step 1045) and obtain the time of the last update for that site and store it in the last update field 460 for that site (step 1050).

The system then determines whether or not it can get the next scheduled update for the site from studying the site content (step 1060). If the system can get the next scheduled update, this information is then stored in the next scheduled update field 470 of the schedules database 270 (step 1065) and then the system moves on to the next site in the database (step 1075). If the system cannot get the next scheduled update, it attempts to predict the next scheduled update (step 1070). This may be accomplished, for example, by a study of the history of the past update times for the site and trying to spot a pattern that the system may use. If it is possible to predict, then the next predicted update field 480 is filled. Then, regardless of the result of the prediction, the controller 110 moves on to the next entry in the schedules database 270 (step 1075).

In some embodiments, this process of maintaining the schedules database 270 may be continued continuously, or depending on the requirements and performance of the system and the size and character of the schedules database 270, this process may only need to be run sparsely in other embodiments. Of course, the process 1000 may be interrupted at any time to service a contact from either a consumer 134 or a web site 124 over an interface device 130 or 120.

It will be apparent to those skilled in the art that various modifications and variations can be made in the system and processes of the present invention without departing from the spirit or scope of the invention. Thus, it is intended that the present invention cover the modifications and variations of this invention provided they come within the scope of the appended claims and their equivalents. In this context, equivalent means each and every implementation for carrying out the functions recited in the claims, even if not explicitly described herein.

What is claimed is:

1. A method of transmitting at least one web site update schedule, comprising:
receiving said update schedule from a plurality of web sites; and
providing the update schedule of selected sites to at least one consumers.

2. The method of claim 1, wherein the update schedules of a web site are received by a registration process which provides its update schedule.

3. The method of claim 1, wherein the update schedule of a web site are received by crawling the web site.

4. The method of claim 1, further comprising sending the update schedule to a consumer in response to identification of one or more web sites in which schedule is desired by a consumer.

5. The method of claim 4, wherein the identified web sites may be revised.

6. The method of claim 4, wherein the update schedule is displayed as desired by the consumer without revising the desired web sites.

7. The method of claim 1, further comprising:
providing consumer access to the desired web sites when the update schedule is displayed.

8. The method of claim 1, further comprising:
tracking one or more consumer interests, said interests relating to subject matter of one or more identified web sites.

9. The method of claim 1, further comprising:
tracking one or more consumer interests, said interests relating to interests of other consumers of a peer group.

10. The method of claim 1, further comprising:
making recommendations of additional web sites which may be of interest to the consumer.

11. The method of claim 10, further comprising:
providing consumer access to additional web sites that are recommended.

12. The method of claim 10, wherein the recommendation relates to consumer interest as measured by content of the web sites whose update schedule's are of interest to the consumer.

13. The method of claim 10, wherein the recommendation relates to consumer interest as measured by interests of members of said consumer peer group.

14. The method of claim 10, wherein the recommendation relates to consumer interest as measured by information obtained from the consumer through registration.

15. The method of claim 1, further comprising:
placing advertisements or promotions on the update schedule of the consumer.

16. The method of claim 15, wherein the advertisements or promotions relate to one or more interests of the consumer where said interests are based on subject matter of the web sites whose update schedules are of interest to the consumer.

17. The method of claim 15, wherein the advertisements or promotions relate to one or more interests of the consumer where said interests are based on interests of the members of the consumer peer group.

18. The method of claim 15, wherein the advertisements or promotions relate to one or more interests of the consumer where said interests are based on information obtained from the consumer through registration.

19. The method of claim 2, further comprising:
allowing a registered web site to provide advertisements or promotions to be displayed to the consumer with the web site update schedule.

20. A system of transmitting at least one web site update schedule, comprising:
means for receiving the update schedule from a plurality of web sites; and
means for providing the update schedule of selected sites to at least one consumer.

21. The system of claim 20, wherein the update schedule of a web site are received by a registration process which provides its update schedule.

22. The system of claim 20, wherein the update schedules of a web site are received by crawling the web site.

23. The system of claim 20, further comprising means for sending the update schedule to a consumer in response to identification of one or more web sites in which schedule is desired by a consumer.

24. The system of claim 23, wherein the identified web sites may be revised.

25. The system of claim 23, wherein the update schedule is displayed as desired by the consumer without revising the desired web sites.

26. The system of claim 20, further comprising:
means for providing consumer access to the desired web sites when the update schedule is displayed.

27. The system of claim 20, further comprising:
means for tracking one or more consumer interests, said interests relating to subject matter of one or more identified web sites.

28. The system of claim 20, further comprising:
means for tracking one or more consumer interests, said interests relating to interests of other consumers of a peer group.

29. The system of claim 20, further comprising:
means for making recommendations of additional web sites which may be of interest to the consumer.

30. The system of claim 29, further comprising:
means for providing consumer access to additional web sites that are recommended.

31. The system of claim 29, wherein the recommendation relates to consumer interest as measured by content of the web sites whose update schedule's are of interest to the consumer.

32. The system of claim 29, wherein the recommendation relates to consumer interest as measured by interests of members of said consumer peer group.

33. The system of claim 29, wherein the recommendation relates to consumer interest as measured by information obtained from the consumer through registration.

34. The system of claim 29, further comprising:
means for placing advertisements or promotions on the update schedule of the consumer.

35. The system of claim 34, wherein the advertisements or promotions relate to one or more interests of the consumer where said interests are based on subject matter of the web sites whose update schedules are of interest to the consumer.

36. The system of claim 34, wherein the advertisements or promotions relate to one or more interests of the consumer where said interests are based on interests of the members of the consumer peer group.

37. The system of claim 34, wherein the advertisements or promotions relate to one or more interests of the consumer where said interests are based on information obtained from the consumer through registration.

38. The system of claim 21, further comprising:
means for allowing a registered web site to provide advertisements or promotions to be displayed to the consumer with the web site update schedule.

39. A system of transmitting web site update schedule, comprising:
a database for receiving update schedule from a plurality of web sites; and
a central processor configured for providing the update schedule of selected sites to at least one consumer.

40. The system of claim 39, wherein the update schedule of a web site are received by a registration process which provides its update schedule.

41. The system of claim 39, wherein the update schedule of a web site are received by crawling the web site.

42. The system of claim 39, wherein the central processor is further configured for further comprising sending the update schedule to a consumer in response to identification of one or more web sites in which schedule is desired by a consumer.

43. The system of claim 42, wherein the identified web sites may be revised.

44. The system of claim 42, wherein the update schedule is displayed as desired by the consumer without revising the desired web sites.

45. The system of claim 39, wherein the processor is further configured for providing consumer access to the desired web sites when the update schedule is displayed.

46. The system of claim 39, wherein the processor is further configured for tracking one or more consumer interests, said interests relating to subject matter of one or more identified web sites.

47. The system of claim 39, wherein the processor is further configured for tracking one or more consumer interests, said interests relating to interests of other consumers of a peer group.

48. The system of claim 39, wherein the processor is further configured for making recommendations of additional web sites which may be of interest to the consumer.

49. The system of claim 48, wherein the processor is further configured for providing consumer access to additional web sites that are recommended.

50. The system of claim 48, wherein the recommendation relates to consumer interest as measured by content of the web sites whose update schedule's are of interest to the consumer.

51. The system of claim 48, wherein the recommendation relates to consumer interest as measured by interests of members of said consumer peer group.

52. The system of claim 48, wherein the recommendation relates to consumer interest as measured by information obtained from the consumer through registration.

53. The system of claim 39, wherein the processor is further configured for placing advertisements or promotions on the update schedule of the consumer.

54. The system of claim 53, wherein the advertisements or promotions relate to one or more interests of the consumer where said interests are based on subject matter of the web sites whose update schedules are of interest to the consumer.

55. The system of claim 53, wherein the advertisements or promotions relate to one or more interests of the consumer where said interests are based on interests of the members of the consumer peer group.

56. The system of claim 53, wherein the advertisements or promotions relate to one or more interests of the consumer where said interests are based on information obtained from the consumer through registration.

57. The system of claim 40, wherein the processor is further configured for allowing a registered web site to provide advertisements or promotions to be displayed to the consumer with the web site update schedule.

58. Computer executable software code stored on a computer readable medium, the code for transmitting at least one web site update schedule, comprising:
code to receiving update schedule from a plurality of web sites; and
code to providing the update schedule of selected sites to at least one consumer.

59. A programmed computer for transmitting web site update schedule, comprising:
memory having at least one region for storing executable program code; and
a processor for executing program code stored in memory, wherein program code includes:
code to receive update schedule from a plurality of web sites; and
code to provide the update schedules of selected sites to at least one consumer.

60. A computer readable medium having computer executable software code stored thereon, the code for transmitting web sites update at least one schedule, comprising:
code to receive update schedule from a plurality of web sites; and
code to provide the update schedule of selected sites to at least one consumer.
